(19) United States
(12) Patent Application Publication
(10) Pub. No.: US 2026/0300897 A1
(43) Pub. Date: Oct. 1, 2026

(54) ENHANCED AUTHENTICATION FOR SECURE PACKAGE DELIVERY

(71) Applicant: International Business Machines Corporation, Armonk, NY (US)

(72) Inventors: Arielle Micaela Goldberg, Blue Bell, PA (US); Nadia Salahuddin, Jackson Heights, NY (US); Michael S. Gordon, Croton on Hudson, NY (US); Kyle Marshall, Hyde Park, NY (US); Kimberly Dyan Laynes, Neptune Beach, FL (US)

(21) Appl. No.: 19/095,739

(22) Filed: Mar. 31, 2025

(51) Int. Cl. G06Q 10/0833; H04L 51/224

(52) U.S. Cl. CPC G06Q 10/0833; H04L 51/224

(57) ABSTRACT

A system of authenticating secure package delivery is provided which includes a client memory and a client processor, The client processor is configured to acquire encoded package data representing package information which identifies a package and encoded location data representing location information which identifies a delivery location, determine whether or not the delivery location identified by the location information is a target delivery location for the package based on a plurality of portions of package information each identifying a package and a plurality of portions of location information each identifying a target delivery location and associated with a corresponding portion of package information, and provide a notification that the delivery location is the target delivery location, or is not the delivery location, based on the determination.

### BACKGROUND

The present application relates to systems and methods for authenticating secure package delivery.

Package or parcel (hereinafter “package”) delivery is a service provided by various package service providers (e.g., private courier companies and postal services) which includes the delivery of packages to residences and businesses. Package delivery is a service that allows vendors to send goods to end consumers quickly and efficiently.

### SUMMARY

A system for authenticating package delivery is provided. In some embodiments, the system includes a client device which includes a client memory and a client processor configured to acquire encoded package data representing package information which identifies a package.

The client processor is also configured to acquire encoded location data representing location information which identifies a delivery location.

The client processor is also configured to determine whether or not the delivery location, identified by the location information, is a target delivery location for the package based on a plurality of portions of package information and a plurality of portions of location information.

Each portion of package information identifying one of a plurality of packages and each portion of location information identifies one of a plurality of target delivery locations for a corresponding package and is associated with a corresponding portion of package information.

The client processor is also configured to, in the case that it is determined that the delivery location is the target delivery location for the package, provide a notification that the delivery location is the target delivery location. In the case that it is determined that the delivery location is not the target delivery location for the package, provide a notification that the delivery location is not the target delivery location.

A system for authenticating secure package delivery is provided which includes a plurality of clients. A computer program product is provided which includes one or more computer-readable storage media and program instructions stored on the one or more computer-readable storage media to perform operations.

In some embodiments, the operations include acquiring encoded package data, representing package information which identifies a package and acquiring encoded location data, representing location information which identifies a delivery location.

The operations also include determining whether or not the delivery location, identified by the location information, is a target delivery location for the package based on a plurality of stored portions of package information and a plurality of stored portions of location information.

Each stored portion of package information identifies a different package and each stored portion of location information identifies a different target delivery location for a corresponding package and is associated with a corresponding stored portion of package information.

The operations also include, in the case that it is determined that the delivery location is the target delivery location for the package, providing a notification that the delivery location is the target delivery location and, in the case that it is determined that the delivery location is not the target delivery location for the package, providing a notification that the delivery location is the not target delivery location.

A computer implemented method of authenticating secure package delivery is provided. In some embodiments, the method includes acquiring, by a client processor, encoded package data, representing package information which identifies a package.

The method also includes acquiring, by a client processor, encoded location data, representing location information which identifies a delivery location.

The method also includes determining, by a client processor, whether or not the delivery location, identified by the location information, is a target delivery location for the package based on a plurality of stored portions of package information and a plurality of stored portions of location information.

Each stored portion of package information identifies a different package and each stored portion of location information identifies a different target delivery location for a corresponding package and is associated with a corresponding stored portion of package information.

The method also includes in the case that it is determined that the delivery location is the target delivery location for the package, providing, by a client processor, a notification that the delivery location is the target delivery location and, in the case that it is determined that the delivery location is not the target delivery location for the package, providing, by a client processor, a notification that the delivery location is not the target delivery location.

### BRIEF DESCRIPTION OF THE DRAWINGS

FIG. 1 shows an example computing environment in which embodiments of the present disclosure can be implemented.

FIG. 2 illustrates example components of a system for authenticating secure package delivery in accordance with features of the present disclosure.

FIG. 3 illustrates an example system for authenticating secure package delivery using location information and package information represented by scanned data in accordance with features of the present disclosure.

FIG. 4 is a flow diagram illustrating a computer implemented method of authenticating secure package delivery using location information and package information represented by scanned data in accordance with features of the present disclosure.

FIG. 5 illustrates an example system for authenticating secure package delivery using package information and location information read from electronic devices via a short range communication protocol in accordance with features of the present disclosure.

FIG. 6 is a flow diagram illustrating a computer implemented method of authenticating secure package delivery using package information and location information read from electronic devices via a short range communication protocol in accordance with features of the present disclosure.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Package or parcel (hereinafter “package”) delivery is a service provided by various service providers (e.g., private courier companies and postal services) which includes the delivery of packages to residences and businesses. Package delivery is an important service because it allows vendors to send goods to end consumers quickly and efficiently.

The last stage of package delivery typically includes the delivery, via package delivery personnel (e.g., delivery drivers), of the packages at their endpoint location (i.e., delivery location), such as residences and businesses. However, packages are often not delivered to their target location (i.e., correct location) and are instead delivered to an incorrect location (e.g., unexpected location), which significantly increases the overall costs to delivery services. For example, inaccurate address information can cause packages to be rerouted, delayed, lost or returned to service providers or vendors, resulting in additional costs for re-shipping, costs for returns processing and potential future loss profits due to unsatisfied customers. In addition, delivery of some packages require an end consumer (or end consumer representative) to be present at the delivery location to confirm secure delivery of the packages.

Features of the present disclosure include systems and methods for efficiently authenticating secure package delivery, reducing the costs to delivery services. Features of the present disclosure authenticate secure package delivery (e.g., confirm that a delivery location for a package is the target delivery location for the package) without requiring an end consumer (or end consumer representative) to be present at the delivery location to verify package delivery.

Features of the present disclosure authenticate secure package delivery by acquiring, at a potential delivery location. encoded data representing package information identifying a package and encoded data representing location information (e.g., an address) identifying the potential delivery location for the package and determining whether or not previously stored location information (which identifies a target location for the package and which is associated with previously stored package information identifying the package) matches the location information (represented by the acquired encoded data) identifying the potential delivery location.

In an embodiment, the encoded data representing the package information and the encoded data representing the location information is optically scannable data (e.g., bar code data, quick response (QR) code data or other optically scannable data). The encoded data representing the package information is acquired, at a potential delivery location of the package, by optically scanning the encoded data of a package identifier attached to the package. The encoded data representing the location information is acquired, at the potential delivery location, by optically scanning encoded data of a location identifier attached to an object at the potential delivery location. In another embodiment, the encoded data representing the package information and the location information is acquired by reading encoded data of an electronic device (e.g., a radio frequency identification (RFID) tag, a smart card or other electronic device) via a short range communication protocol.

In an embodiment, secure package delivery authentication is confirmed by the client computing device at a potential delivery location. In another embodiment, secure package delivery is authenticated via communications between the client computing device and a server computing device over a network.

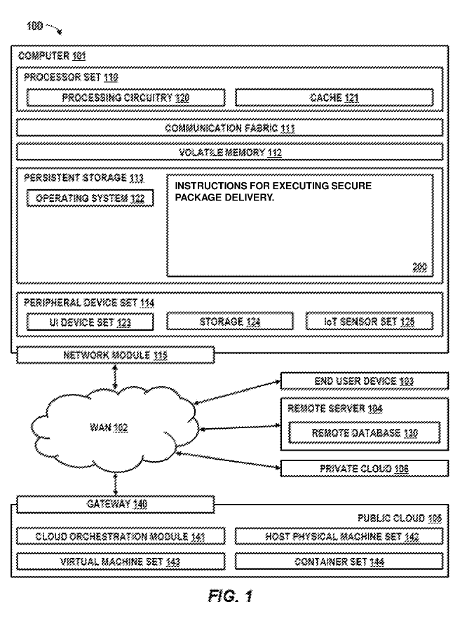

FIG. 1 shows a computing environment 100 in which embodiments of the present disclosure can be implemented. Computing environment 100 contains an example of an environment for the execution of at least some of the computer code involved in performing the inventive methods, such as instructions 200 for authenticating secure package delivery. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

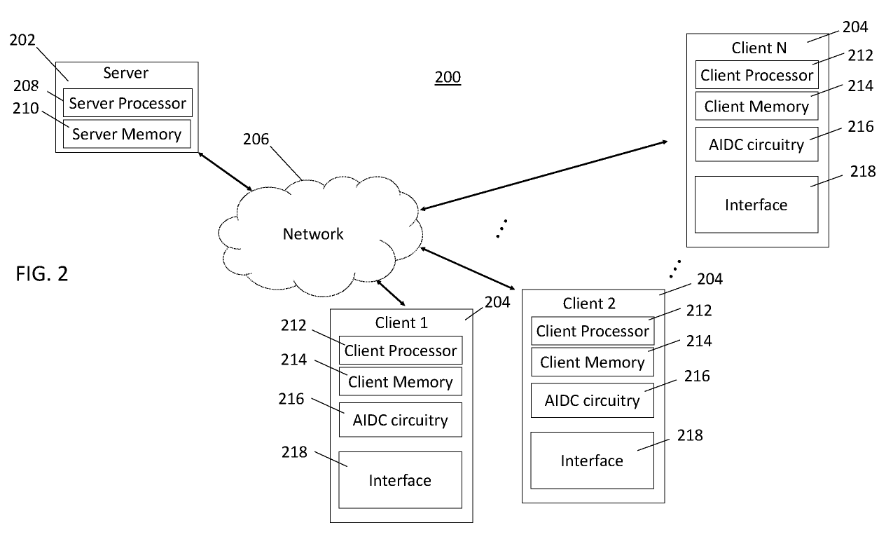

FIG. 2 illustrates example components of a system 200 for authenticating secure package delivery in accordance with features of the present disclosure. As shown in FIG. 2, system 200 includes a server 202, a plurality of clients 204 (client 1, client 2, … client N) and a network 206.

Network 206 may include one or more networks such as, for example, one or more wireless networks (e.g., via WiFi, Bluetooth, and other wireless standards), one or more wired networks (e.g., Ethernet) or a combination of wired and wireless networks.

Server 202 is, for example, COMPUTER 101 shown in FIG. 1. Server 202 includes server processor 208 (e.g., a processor of processor set 110 in FIG. 1) and server memory 210.

Server processor 208 is configured to store, in the server memory 210 (or alternatively in storage, such as storage 124 shown in FIG. 1), a plurality of portions of package information, each identifying one of a plurality of packages to be delivered to a target delivery location (e.g., an intended address of a personal residence, a business residence, an office of a business residence or other address) for a package. Server processor 208 is also configured to store, in the server memory 210 (or alternatively in storage, such as storage 124 shown in FIG. 1), a plurality of portions of location information, each identifying one of a plurality of target delivery locations and each associated with a corresponding portion of package information.

Server 202 is configured to receive, from each client 204 (e.g., client 1, client 2, … client N) via network 206, a plurality of portions of package information, each represented by first encoded data acquired (e.g., scanned or read from via a short range communication protocol) by the client 204 and each identifying a different package for potential delivery at a delivery location. Server 202 is also configured to receive, from each client 204 via network 206, a plurality of portions of location information. Each portion of location information is represented by second encoded data acquired (e.g., scanned or read from via a short range communication protocol) by the client 204. Each portion of location information is also acquired at a different location and identifies the different location (e.g., an address of a personal residence, a business residence, an office of a business residence or other address) for a package to potentially be delivered.

Server 202 is further configured to receive, from each client 204 via network 206, requests for confirmation of whether or not secure delivery of each of a plurality of packages is authenticated (e.g., request for confirmation of whether or not a delivery location, represented by a portion of the acquired location information, for a package is the target delivery location for the package). As described in more detail below, in response to receiving a request, from a client via network 206, for confirmation of whether or not secure delivery of a package is authenticated, server processor 208 is configured to determine whether or not secure delivery of a package is authenticated by determining whether or not stored location information associated with the stored package information matches the location information received from the client 204 and send a reply message to the client 204, via network 206, confirming whether or not secure delivery of a package is authenticated.

Each client 204 is, for example, an END USER DEVICE 103 shown in FIG. 1. For example, each client 204 is, for example, a computing device used by a different delivery person (e.g., delivery driver). Client 204 includes a client processor 212, client memory 214, automatic identification and data capture (AIDC) circuitry 216 and interface 218. Examples of a client 204 include, but are not limited to, a handheld portable scanning device, a tablet computer, a smart phone, a smart watch or other wearable computer, or any other form of computer or mobile device now known or to be developed in the future that is capable of performing various tasks for authenticating secure package delivery in accordance with features of the present disclosure.

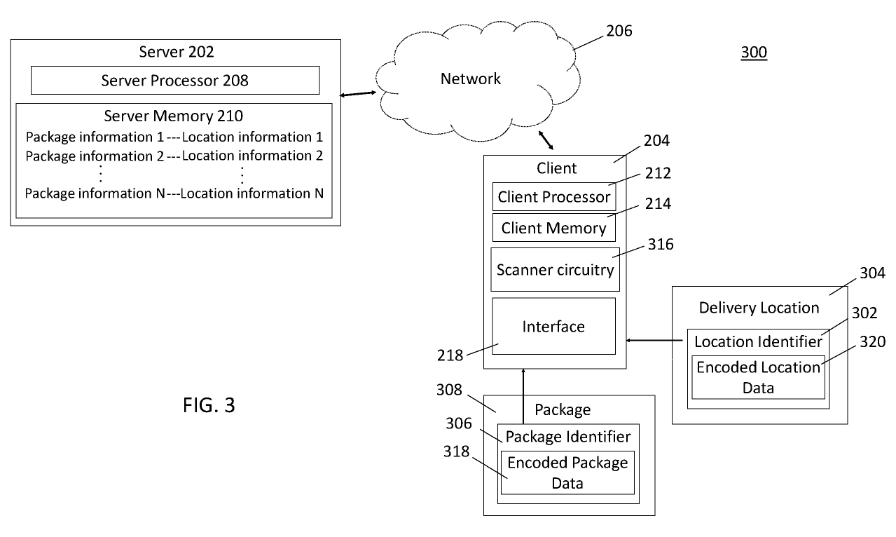

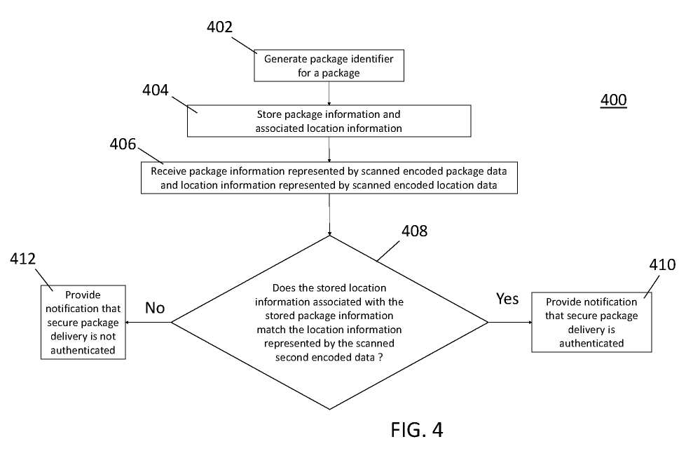

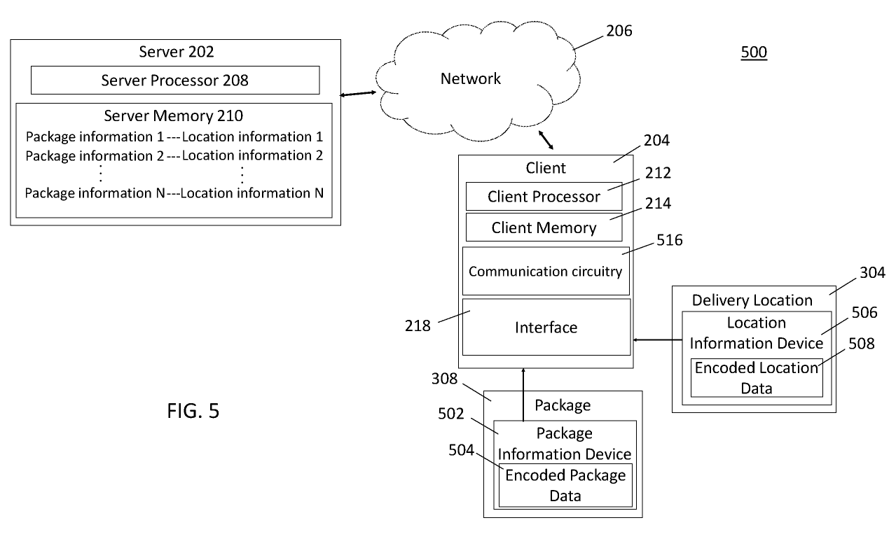

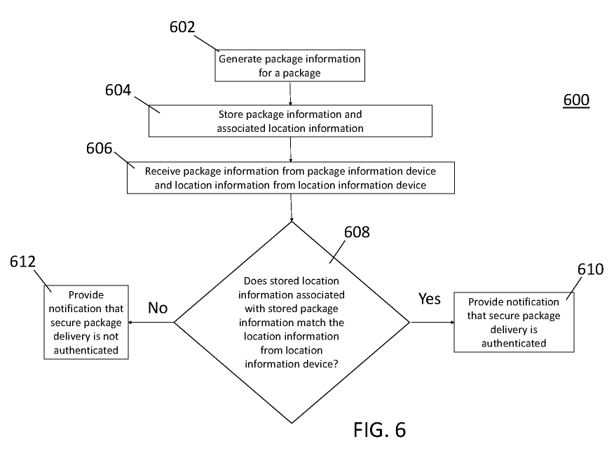

AIDC circuitry 216 is circuitry configured to acquire encoded data (e.g., encoded data representing package information identifying a package and encoded data representing location information identifying a delivery location for a package) and decode (e.g., convert) the encoded data into package information and location information. In an embodiment, as described in more detail below with regard to FIG. 3 and FIG. 4, in AIDC circuitry 216 is optical scanner circuitry configured to acquire encoded data by optically scanning the encoded data (e.g., bar code data, QR code data or other optically scannable encoded data). In another embodiment, as described in more detail below with regard to FIG. 5 and FIG. 6, AIDC circuitry 216 is communication circuitry configured to acquire encoded data by reading the encoded data from an electronic device (e.g., RFID tag, a smart card or other electronic device) via a short range communication protocol.

Interface 218 (e.g., user interface) is, for example, a user interface which includes a touch screen display configured to display information to a user and/or receive user inputs from a user. Client processor 212 is configured to receive user inputs (e.g., inputs from a delivery person) via interface 218 or alternatively receive user inputs aurally via a microphone (not shown). Client processor 212 is configured to display information via interface 218, such as notification information notifying a delivery person that secure package delivery is authenticated or alternatively, aurally provide information via speakers (not shown), one or more lights (not shown) and/or haptic feedback on a wearable device such as a smart watch worn by the delivery person.

Client 204 may also include a network adapter card or network interface (not shown) configured to wirelessly transmit to server 202, via network 206, information (e.g., package information identifying a package and location information identifying a delivery location) and wirelessly receive from server 202, via network 206, authentication information (e.g., a message confirming that secure package delivery is authenticated or a message indicating that secure package delivery is not authenticated). The network adapter card or network interface can also be used by the client 204 to read encoded data from an electronic device via the short range communication protocol (e.g., a short range wireless communication protocol).

Client processor 212 of each client 204 is configured to receive package information identifying a package for potential delivery at a delivery location. Client processor 212 of each client 204 is also configured to receive location information identifying a delivery location (e.g., address) to which the package may potentially be delivered.

In an embodiment, client processor 212 is configured to control AIDC circuitry 216 to acquire the encoded data by optically scanning the encoded data (e.g., bar code data, quick response (QR) code data, or other optically scannable encoded data) representing information (e.g., alphanumeric package information identifying a package and alphanumeric location information identifying a delivery location for the package). Client processor 212 is also configured to receive the information represented by the scanned encoded data by controlling AIDC circuitry 216 to decode (e.g., convert) the encoded data into alphanumeric character information represented by the encoded data.

In another embodiment, client processor 212 is configured to control AIDC circuitry 216 to acquire the encoded data representing the package information by reading the encoded data from an electronic device (e.g., an RFID tag, a smart card or another electronic device) via a short range communication protocol (e.g., RFID, NFC, Bluetooth, ZigBee, Wi-Fi, Z-Wave, Ultra-Wideband (UWB), Ethernet or other short range communication protocol). The encoded data can be read via a wired or wireless short range protocol). Client processor 212 is also configured to receive the information represented by the encoded data read from an electronic device by controlling AIDC circuitry 216 to decode (e.g., convert) the encoded data into alphanumeric character information represented by the encoded data.

In an embodiment, client processor 212 is configured to send, to server 202 via network 206, the received package information and location information and requests for confirmation of whether or not secure delivery of packages is authenticated (i.e., requests for confirmation of whether or not the delivery location identified by the location information is the target delivery location). Client processor 212 of each client 204 is also configured to receive, from server 202 via network 206, reply messages confirming whether or not secure delivery of packages is authenticated.

In another embodiment, client processor 212 is configured to determine whether or not secure delivery of packages is authenticated without communicating with the server 202 over network 206. For example, as described in more detail below, client processor 212 determines whether or not secure delivery of a package is authenticated (i.e., whether or not the delivery location identified by the location information is the target delivery location) by using portions of package information and associated portions of location information stored at the client 204.

Client processor 212 is also configured to provide (e.g., visually display and/or aurally provide to a delivery person and/or haptic feedback on a wearable device such as a smart watch worn by the delivery person.) notification that secure package delivery is authenticated or not authenticated.

Client processor 212 is also configured to provide (e.g., via email, text, or push notification) confirmation to an end consumer that a package has been delivered at the target delivery location. For example, the server processor 208 is also configured to store portions of end consumer identification information. Each portion of end consumer identification information identifies contact information (e.g., email address, cell phone number, or other contact information) of an end consumer for a target delivery location (i.e., the end consumer associated with the target delivery). Each portion of end consumer identification information is also associated with a stored portion of package information. In response to receiving, from the server, a reply that the delivery location identified by the location information is the target delivery location, the client processor 212 is configured to send, using the contact information of the end consumer of the target delivery location, confirmation of package delivery at the target delivery location.

FIG. 3 illustrates an example system 300 for authenticating secure package delivery using location information and package information represented by scanned data in accordance with features of the present disclosure. As shown in FIG. 3, system 300 includes server 202, client 204, network 206, a location identifier 302, and a package identifier 306.

For simplified explanation purposes, system 300 shown in FIG. 3 includes a single client 204 (e.g., computing device used by a package delivery person) and a single package identifier 306 which includes first encoded data representing package information identifying a single package 308 for delivery at a delivery location 304. However, in practice, features of the present disclosure are implemented in a system which includes a plurality of clients (e.g., a plurality of computing devices each used by a different package delivery person) and a plurality of package identifiers each identifying a different package for delivery at a corresponding delivery location. In addition, for simplified explanation purposes, system 300 shown in FIG. 3 includes a single location identifier 302 which includes second encoded data representing location information uniquely identifying a delivery location 304. However, in practice, features of the present disclosure are implemented using a plurality of location identifiers each including encoded data representing location information.

Location identifier 302 includes, for example, a bar code, a QR code, or other type of optically scannable encoded location data 320 used to represent location information (e.g., an address) which identifies delivery location 304 (e.g., a personal residence, a business residence, an office of a business residence, and the like). Each location identifier is attached (e.g., directly attached or indirectly attached) to an object (e.g., a mailbox, a door, a window, or other object accessible by a delivery person) at a corresponding delivery location prior to being scanned at the corresponding delivery location (e.g.., by scanner circuitry of a computing device operated by a delivery driver). For example, location identifier 302 is attached to an object at delivery location 304.

Location identifiers can be generated using various techniques. For example, location identifiers can be generated as encoded data representing an electronic product code (EPC) for each unique postal address. a unique hexadecimal value can be generated for each United States Postal Service (USPS) postal address). Because the location identifiers (i.e., the encoded data of the location identifiers) are programmable, location identifiers can be customized (e.g., by package service provider). For example, for a house, a location identifier can be programmed to include the address of the house. Alternatively, for apartment buildings with multiple residences or company offices with multiple individual offices, a unique name can be generated for each location identifier at an individual residence (e.g., apartment) or individual office. In addition, notification that the package has been delivered can be sent to the unique person assigned to the location at which the package was delivered. Location identifiers can be generated by one or more computing devices (e.g., server 202 or one or more other computing devices (not shown

Package identifier 306 includes, for example, a bar code, a QR code or other type of scannable encoded package data 318 which represents package information uniquely identifying package 308 to be delivered to a target delivery location. For example, for each package provided by a vendor to a delivery service provider, a package identifier 306 is generated (i.e., the scannable encoded data of a package identifier is generated) to uniquely identify a package to be delivered to a target delivery location. Each package identifier 306 is attached (e.g., directly attached or indirectly attached) to a package to be delivered to a target delivery location. The encoded package data of each package identifier can be generated by a computing device (e.g., server 202 or another computing device (not shown)).

Server processor 208 is configured to store, in the server memory 210 (or alternatively in storage, such as storage 124 shown in FIG. 1), a plurality of portions of package information (e.g., package information 1, package information 2, … package information N as shown in FIG. 3). Each portion of package information identifies one of a plurality of packages (i.e., each portion of package information identifies a different package). Server processor 208 is also configured to store, in the server memory 210 (or alternatively in storage, such as storage 124 shown in FIG. 1), a plurality of portions of location information (e.g., location information 1, location information 2, … location information N as shown in FIG. 3). Each portion of location information identifies one of a plurality of delivery locations for a corresponding package. In addition, each portion of location information is associated with a corresponding portion of package information. For example, as shown in FIG. 3, package information 1 is stored along with its associated location information 1 and package information 2 is stored in server memory 210 along with its associated location information 2. Server processor 208 is configured to store a portion of location information for each of a number N of different packages. Accordingly, for the Nth package, server processor 208 is configured to store package information N along with its associated location information N.

As shown in the embodiment in FIG. 3, client 204 includes scanner circuitry 316 as an example of the AIDC circuitry 216 shown in FIG. 2. Scanner circuitry 316 includes circuitry configured to optically scan encoded package data 318 from the package identifier 306 and encoded location data 320 from location identifier 302 and decode the scanned data. Scanner circuitry 316 includes, but is not limited to, image or laser sensors, a light source (e.g., a light emitting diode(LED)) and a decoder for converting scanned encoded data into alphanumeric information.

Client processor 212 is configured to control scanner circuitry 316 to acquire the encoded data of package identifier 306 by optically scanning the encoded data (e.g., bar code data, quick response (QR) code data, or other optically scannable encoded data) representing package information identifying package 308. Client processor 212 is configured to control scanner circuitry 316 to acquire the encoded data of location identifier 302 by optically scanning the encoded data representing location information identifying the delivery location 304.

Client processor 212 is also configured to receive the package information and the location information represented by the scanned encoded data by controlling scanner circuitry 316 to decode (e.g., convert) the scanned encoded data into the corresponding package information and location information.

In an embodiment, client processor 212 is configured to send, to server 202 via network 206, the received package information represented by the scanned encoded data of the package identifier 306, the received location information represented by the scanned encoded data of the location identifier 302 and requests for confirmation of whether or not secure delivery of package 308 is authenticated (i.e., confirmation of whether or not the delivery location 304 identified by the location information is the target delivery location). Client processor 212 is also configured to receive, from server 202 via network 206, reply messages confirming whether or not secure delivery of packages is authenticated. By way of example, if a secure delivery of a package is not authenticated, a delivery person may not leave the package at that delivery location.

In another embodiment, client processor 212 is configured to determine whether or not secure delivery of packages is authenticated without communicating with the server 202 over network 206. For example, client processor 212 is configured to store (e.g., in client memory 214 or alternatively in client storage (not shown)) portions of package information (e.g., information for packages to be delivered by a delivery person) and their associated portions of location information (e.g., location information for the delivery person’s area). Client processor 212 determines whether or not secure delivery of a package is authenticated (i.e., whether or not the delivery location identified by the location information is the target delivery location) by using the portions of package information and associated portions of location information stored at the client 204.

Client processor 212 is also configured to provide (e.g., via email, text, or push notification) confirmation to an end consumer that a package has been delivered at the target delivery location. For example, the client processor 212 is also configured to store portions of end consumer identification information. Each portion of end consumer identification information identifies contact information (e.g., email address, cell phone number, or other contact information) of an end consumer for a target delivery location (i.e., the end consumer associated with the target delivery). Each portion of end consumer identification information is also associated with a stored portion of package information. In response to the client processor 212 determining that the delivery location identified by the location information is the target delivery location, the client processor 212 is configured to send, using the contact information of the end consumer of the target delivery location, confirmation of package delivery at the target delivery location.

FIG. 4 is a flow diagram illustrating a computer implemented method 400 of authenticating secure package delivery using location information and package information represented by scanned data in accordance with features of the present disclosure. For simplification purposes, the example method 400 shown in FIG. 4 describes authenticating secure delivery of a single package at a single delivery location. However, in practice, the example method 400 shown in FIG. 4 is implemented for authenticating secure delivery of a plurality of packages at different delivery locations. In addition, the example method 400 shown in FIG. 4 includes a single location identifier (e.g., representing an address of a delivery location) uniquely identifying the single delivery location. In practice, the example method 400 shown in FIG. 4 is implemented using a plurality of location identifiers, each of which is placed (e.g., on a mailbox, a door, or other object), prior to implementing the method 400, at a different delivery location.

As shown at block 402, the method 400 includes generating a package identifier. For example, a package service provider receives (e.g., from a vendor) a package along with delivery location information (e.g., end consumer address) representing a target delivery location at which the package is intended to be delivered. The delivery location information is then input (e.g., via user input) to a computing device (e.g., server 202 or another computing device (not shown)). The server processor 208 generates the package identifier 306 which includes the encoded data (e.g., encoded barcode data, encoded QR code data or other optically scannable encoded data) uniquely identifying a package. Each package identifier is attached to a corresponding package to be delivered.

As shown at block 404, the method 400 includes storing (e.g., in server memory 210 or alternatively in storage, such as storage 124 shown in FIG. 1) portions of package information each represented by encoded scannable data of a corresponding package identifier generated at block 402 and storing portions of location information (e.g. addresses provided by a vendor) each associated with a corresponding portion of package information. For example, a plurality of portions of package information (e.g., package information 1, package information 2, … package information N as shown in FIG. 3) is stored, in server 202, with each portion of package information identifying one of a plurality of packages. A plurality of portions of location information (e.g., location information 1, location information 2, … location information N as shown in FIG. 3) is also stored, in server 202, with each portion of location information identifying one of a plurality of delivery locations for a corresponding package. In addition, each portion of location information is stored with an associated corresponding portion of package information (e.g., location information 1 is associated with package information 1, location information 2 is associated with package information 2, … location information N is associated with package information N).

As shown at block 406, the method 400 includes receiving, by the client processor 212, package information (i.e., information identifying the package 308) represented by scanned encoded package data of the package identifier 306 and location information (i.e., information identifying the delivery location 304) and represented by scanned encoded location data of the location identifier 302). The package information and location information are received by the client processor 212 by scanning the encoded package data and the encoded location data and decoding (e.g., converting) the encoded package data into the package information and decoding the encoded location data into the location information. For example, when a deliverer (not shown) arrives at the delivery location 304, the encoded data of package identifier 306 attached to the package 308 is scanned by client 204, using scanner circuitry 316, and the encoded data of the location identifier 302 at the delivery location 304 (e.g., attached to a mailbox, a door or other object at the delivery location 304) is also scanned by client 204 using scanner circuitry 316. The client processor 212 then receives the package information by decoding the scanned encoded package data into the package information and receives the location information by decoding the scanned encoded location data into the location information.

As shown at decision block 408, the method 400 includes determining whether or not the stored location information associated with the stored package information matches the location information represented by the scanned encoded location data (i.e., determining whether or not secure package delivery is authenticated). In the case that it is determined, at decision block 408, that the stored location information associated with the stored package information matches the location information represented by the scanned encoded location data (Yes decision), then notification is provided (e.g., visually via a display and/or aurally, and/or by haptic feedback on wearable device such as a), at block 410, to the delivery person that the delivery location is the target delivery location for the package (i.e., that secure package delivery is authenticated). For example, the notification can include displaying a message “Correct Address” or another message notifying the delivery person that secure package delivery is authenticated. Accordingly, in response to being notified that secure package delivery is authenticated, the delivery person leaves the package at the delivery location. In addition, as described above, a notification can also be sent (e.g., via email, text, or push notification) that the package has been delivered at the target delivery location.

However, in the case that it is determined, at decision block 408, that the stored location information associated with the stored package information does not match the location information represented by the scanned encoded location data (No decision), then notification is provided (e.g., visually via a display and/or aurally, and/or by haptic feedback on a wearable device such as a smart watch), at block 412, to the delivery person that the delivery location is not the target delivery location for the package (i.e., that secure package delivery is not authenticated). For example, the notification can include displaying a message “Incorrect Address” or another message notifying the delivery person that secure package delivery is not authenticated. In response to being notified that secure package delivery is not authenticated, the package identifier 306 on the package 308 and the location identifier 302 at the delivery location 304 can be re-scanned by scanner circuitry 316.

In an embodiment, secure delivery of each package is authenticated via communication between the client 204 and the server 202 via network 206. The client 204 sends, to the server 202 via network 206, the package information represented by the encoded data of a corresponding scanned package identifier, the location information represented by the encoded location data of a corresponding scanned location identifier. In addition, the client 204 sends, to the server 202 via network 206, a request for confirmation of whether or not secure delivery of a package is authenticated and receives, from the server 202 via network 206, confirmation of whether or not secure delivery of the package is authenticated. For example, client 204 sends, to the server 202 via network 206, the scanned package information (i.e., information identifying the package 308 and represented by the scanned encoded package data of package identifier 306) and the scanned location information (e.g., information corresponding to an address of delivery location 304) represented by the scanned encoded location data of location identifier 302. Server processor 208 searches server memory 210 (or alternatively storage, such as storage 124 shown in FIG. 1) for the stored package information corresponding to the scanned package information sent by the client 204 and determines whether or not the stored location information associated with the stored package information matches the scanned location information sent by the client 204.

In the case that server processor 208 determines that the stored location information associated with the stored package information matches the location information represented by the scanned encoded location data and sent by the client 204, then server processor 208 sends, via network 206, an authentication message to the client 204 confirming that the delivery location 304 is the target delivery location for the package 308 (i.e., that secure package delivery is authenticated). Notification of secure package delivery authentication is then provided (e.g., by client processor 212) via interface 218 to the delivery person. For example, the delivery person is notified that the delivery location is the target delivery location for the package (i.e., that secure package delivery is authenticated) by displaying a notification, for example, visually by text or graphics. Alternatively, the delivery person is aurally notified and/or by haptic feedback on a wearable device such as a smart watch that secure package delivery is authenticated. In addition, an end consumer is also notified that the package was delivered to the target delivery location (e.g., the address represented by the location identifier).

In the case that server processor 208 determines that the stored location information associated with the stored package information does not match the location information represented by the scanned encoded location data and sent by the client 204, then server processor 208 sends, via network 206, a message to the client 204 that the delivery location 304 is not the target delivery location for the package 308 (i.e., that secure package delivery is not authenticated). Notification that secure package delivery is not authenticated is then provided (e.g., by client processor 212) via interface 218 to the delivery person. For example, the delivery person is visually notified that secure package delivery is not authenticated by displaying a message, via one or more lights, or is aurally notified that secure package delivery or by haptic feedback on a wearable device such as a smart watch is not authenticated (e.g., via speakers).

In another embodiment, portions of package information and their associated portions of location information are stored at the client 204 (e.g., in client memory 214 or alternatively in client storage (not shown)) and confirmation of whether or not secure delivery of each package is authenticated is confirmed by the client 204, at corresponding delivery locations, without communicating with the server 202 over network 206. That is, secure package delivery can be authenticated at the delivery location by the client 204 without communication between the client 204 and the server 202. For example, prior to a delivery person arriving at the delivery location 304 (e.g., prior to a delivery person starting a daily route), portions of package information (e.g., information for packages to be delivered by the delivery person on a particular day) and their associated portions of location information (e.g., location information for the delivery person’s area) are stored at the client 204 (e.g., in client memory 214 or alternatively in client storage (not shown)). When the delivery person arrives at the delivery location 304, the delivery person scans the encoded package data of the package identifier 306 attached to the package 308 and scans the encoded location data of the location identifier 302 at the delivery location 304 (e.g., on a mailbox at the delivery location 304). The client processor 212 then receives the scanned package information and the scanned location information in the same manner as described above. However, because portions of package information and their associated portions of location information are stored at the client 204 (e.g., in client memory 214), the client processor 212 can authenticate secure package delivery by searching for the stored package information (i.e., the stored portion of package information) corresponding to the scanned package information, and determines whether or not the stored location information (i.e., the stored portion of location information) associated with the stored package information in the client memory 214 matches the location information represented by the scanned location encoded data.

In the case that client processor 212 determines that the stored location information associated with the stored package information matches the location information represented by the scanned encoded location data, notification of secure package delivery authentication is then provided, by client processor 212 via interface 218, to the delivery person. For example, the delivery person is notified that secure package delivery is authenticated by displaying the notification. Alternatively, the delivery person is aurally notified that secure package delivery is authenticated. Alternatively, the delivery person is notified by haptic feedback on a wearable device such as a smart watch that the secure package was authenticated. In addition to notifying a delivery person that secure package delivery is authenticated, an end consumer is also notified that secure package delivery is authenticated (e.g., that the package was delivered to the target delivery location (e.g., target address).

In the case that client processor 212 determines that the stored location information associated with the stored package information does not match the location information represented by the scanned encoded location data, notification that secure package delivery is not authenticated is provided (e.g., by client processor 212) via interface 218 to the delivery person. For example, the delivery person is notified that secure package delivery is not authenticated by displaying a message that the delivery location is not correct. Alternatively, the delivery person is aurally notified that secure package delivery is not authenticated. Alternatively, the delivery person is notified by haptic feedback on a wearable device such as a smart watch that the secure package was not authenticated.

In the embodiments described above, location information and package information are represented by scannable encoded data (e.g., bar code data, QR code data, or other optically scannable data) representing location information and package information. However, in another embodiment, encoded data representing the location information and package information are read, by a client, from an electronic device via a short range communication protocol.

FIG. 5 illustrates an example system 500 for authenticating secure package delivery using package information and location information read from electronic devices via a short range communication protocol in accordance with features of the present disclosure. As shown FIG. 5, system 500 includes server 202, client 204 and network 206. System 500 also includes package information device 502 and location information device 506. Client 204 shown in FIG. 6. includes communication circuitry 516 as an example of the AIDC circuitry 216 shown in FIG. 2.

For simplified explanation purposes, system 500 includes a single client 204 (e.g., computing device used by a package delivery person), a single package information device 502 which includes encoded data 504 representing package information uniquely identifying a single package 308 for delivery at a single delivery location 304. However, in practice, features of the present disclosure are implemented in a system which includes a plurality of clients (e.g., a plurality of computing devices each used by a different package delivery person) and a plurality of package information devices 502 each including encoded data 504 representing package information uniquely identifying a different package for delivery at a corresponding delivery location 304. In addition, for simplified explanation purposes, system 500 includes a single location information device 506 which includes encoded location data 508 representing location information uniquely identifying the delivery location 304. However, in practice, features of the present disclosure are implemented using a plurality of location information devices, each including encoded location data representing location information uniquely identifying a different delivery location.

Server processor 208 is configured to store a plurality of portions of package information (e.g., package information 1, package information 2, … package information N as shown in FIG. 5) each identifying one of a plurality of packages. Server processor 208 is also configured to store a plurality of portions of location information (e.g., location information 1, location information 2, … location information N as shown in FIG. 5) each identifying one of a plurality of delivery locations for a corresponding package and being associated with a corresponding portion of package information.

Package information device 502 is an electronic device (e.g., RFID tag, smart card or other electronic device) which includes encoded package data 504 representing package information identifying package 308. The encoded package data 504 is read, by client 204 (e.g., client processor 212 of client 204) via a short range communication protocol (e.g., RFID, NFC, Bluetooth, ZigBee, Wi-Fi, Z-Wave, Ultra-Wideband (UWB), Ethernet or other short range wired or wireless communication protocol). For example, for each package provided by a vendor to a delivery service provider, package information device 302 (i.e., the encoded data representing the package information is generated and the package information device is attached to (e.g., directly attached or indirectly attached) to a package 308 prior to being delivered by a delivery driver.

Location information device 506 is an electronic device (e.g., RFID tag, smart card or other electronic device) which includes encoded location data 508 representing delivery location information identifying delivery location 304. The encoded location data 508 is read, by client 204 (e.g., client processor 212 of client 204) via a short range communication protocol (e.g., RFID, NFC, Bluetooth, ZigBee, Wi-Fi, Z-Wave, Ultra-Wideband (UWB), Ethernet or other short range wired or wireless communication protocol). The encoded location data of each location information device represents location information identifying a delivery location. Similar to the location identifiers described above, location information can be generated for each United States Postal Service (USPS) postal address and stored. Each location information device (including the encoded data representing a corresponding delivery location) is generated and attached to (e.g., directly attached or indirectly attached) to an object (e.g., a mailbox, a door, a window, or other object accessible by a delivery person) at the corresponding delivery location prior to being scanned by a device (e.g., client 204) operated by a delivery driver.

As shown in FIG. 6, client 204 includes communication circuitry 516. Communication circuitry 516 is hardware circuitry configured to transmit and receive signals (e.g., electromagnetic interrogation pulses), read and transmit data, and encode and decode data according to one or more short range communication protocols. Communication circuitry 516, includes, but is not limited to an antenna, a transceiver (e.g., a radio transceiver ), a digital to analog converter, an encoder and a decoder.

FIG. 6 is a flow diagram illustrating a computer implemented method 600 of authenticating secure package delivery using package information and location information read from electronic devices via a short range communication protocol in accordance with features of the present disclosure.

For simplification purposes, the example method 600 shown in FIG. 6 describes authenticating secure delivery of a single package at a single delivery location. However, in practice, the example method 600 shown in FIG. 6 is implemented for authenticating secure delivery of a plurality of packages at different delivery locations. In addition, the example method 600 shown in FIG. 6 includes a portion of location information in a single location information device. In practice, the example method 600 shown in FIG. 6 is implemented using location information in each of a plurality of location information devices at a different delivery location.

As shown at block 602, the method 600 includes generating package information for a package. For example, a package service provider receives (e.g., from a vendor) a package 308 along with delivery location information (e.g., end consumer address) representing a target delivery location at which the package 308 is intended to be delivered. The delivery location information is then input (e.g., via user input) to a computing device (e.g., server 202) at the package service provider location. The server processor 208 generates the package information uniquely identifying the package 308 to be delivered.

As shown at block 604, the method 600 includes storing (e.g., in server memory 210 or alternatively in storage, such as storage 124 shown in FIG. 1) the package information generated at block 602 and the location information associated with the package information. For example, a plurality of portions of package information (e.g., package information 1, package information 2, … package information N as shown in FIG. 2) is stored, in server 202, with each portion of package information identifying one of a plurality of packages. A plurality of portions of location information (e.g., location information 1, location information 2, … location information N as shown in FIG. 2) is also stored, in server 202, with each portion of location information identifying one of a plurality of delivery locations for a corresponding package. In addition, each portion of location information is stored with an associated corresponding portion of package information.

As shown at block 606, the method 600 includes receiving, by the client 204 via a short range communication protocol (e.g., NFC), package information (e.g., represented by encoded package data 504) from a package information device (e.g., package information device 502) and location information (e.g., represented by encoded location data 508) from a location information device (e.g., location information device 506). For example, when a delivery person (not shown) arrives at the delivery location 304, the delivery person places the client 204 on or in a vicinity of the package information device 502 on package 308 such that encoded package data 504, of package information device 502, representing the package information identifying package 308 is read, by the client processor 212 via a short range communication protocol, from the package information device 502. In addition, the delivery person places the client 204 on or in a vicinity of the location information device 506 at the delivery location 304 such that the encoded location data 508, of location information device 506, representing the location information identifying delivery location 304 is read, by the client 204 via a short range communication protocol, from the location information device 502. The package information and the location information are then received by the client processor 212 by converting and decoding the encoded data (encoded package data 504 and the encoded location data 508) as described above.

As shown at decision block 608, the method 600 includes determining whether or not the stored location information (i.e., stored at the server 202 or at the client 204) associated with the stored package information matches the location information received by the client (e.g., client 204) from the location information device (e.g., location information device 506). In the case that it is determined, at decision block 608, that the stored location information associated with the stored package information matches the location information received at the client from the location information device (Yes decision), then notification is provided (e.g., visually via a display and/or aurally, and/or by haptic feedback on a wearable device such as a smart watch), at block 610, to the delivery person that the delivery location is the target delivery location for the package (i.e., that secure package delivery is authenticated). However, in the case that it is determined, at decision block 608, that the stored location information associated with the stored package information does not match the location information received at the client from the location information device (No decision), then notification is provided (e.g., visually via a display and/or aurally, and/or by haptic feedback on a wearable device such as a smart watch), at block 612, to the delivery person that the delivery location is not the target delivery location for the package (i.e., that secure package delivery is not authenticated).

As described above with regard to FIG. 4, secure delivery of each package can be authenticated via communication between the client 204 and the server 202 via network 206. In another embodiment, portions of package information and their associated portions of location information are stored at the client 204 and confirmation of whether or not secure delivery of each package is authenticated is confirmed by the client 204, at corresponding delivery locations, without communicating with the server 202 over network 206.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A system for authenticating secure package delivery, the system comprising:
a client memory; and
a client processor configured to:
acquire encoded package data, representing package information which identifies a package;
acquire encoded location data, representing location information which identifies a delivery location;
determine whether or not the delivery location, identified by the location information, is a target delivery location for the package based on:
a plurality of portions of package information, each portion of package information identifying one of a plurality of packages;
a plurality of portions of location information, each portion of location information identifying one of a plurality of target delivery locations for a corresponding package and each portion of location information being associated with a corresponding portion of package information; and
in a case that it is determined that the delivery location is the target delivery location for the package, provide a notification that the delivery location is the target delivery location; and
in a case that it is determined that the delivery location is not the target delivery location for the package, provide a notification that the delivery location is not the target delivery location.

2. The system of claim 1, wherein the client processor is further configured to:
store, in the client memory, the plurality of portions of package information;
store, in the client memory, each of the plurality of portions of location information in association with the corresponding portion of package information; and
determine whether or not the delivery location, identified by the location information, is the target delivery location by:
searching, in the client memory, for a stored portion of package information corresponding to the package information which identifies the package; and
determining whether or not a stored portion of location information, associated with the stored portion of package information, matches the location information which identifies the delivery location.

3. The system of claim 1, wherein the client processor is further configured to acquire the encoded package data by optically scanning the encoded package data of a package identifier attached to the package.

4. The system of claim 1, wherein the client processor is further configured to acquire the encoded location data by optically scanning the encoded location data of a location identifier attached to an object at the delivery location.

5. The system of claim 1, wherein the client processor is further configured to acquire the encoded package data by reading, via a short range communication protocol, the encoded package data of a package information device attached to the package.

6. The system of claim 1, wherein the client processor is further configured to acquire the encoded location data by reading, via a short range communication protocol, the encoded location data of a location information device attached to an object at the delivery location.

7. The system of claim 1, wherein the client processor is further configured to
decode the encoded package data into the package information which identifies the package; and
decode the encoded location data into the location information which identifies the delivery location.

8. The system of claim 1, wherein the client processor is further configured to determine whether or not the delivery location, identified by the location information, is a target delivery location for the package by:
sending, to a server via a network, the package information and the location information;
sending, to the server via the network, a request for confirmation of whether or not the delivery location identified by the location information is the target delivery location; and
receiving, from the server via the network, the confirmation of whether or not the delivery location, identified by the location information, is the target delivery location.

9. The system of claim 8, wherein the confirmation, received from the server, of whether or not the delivery location, identified by the location information, is the target delivery location is a confirmation of whether or not a stored portion of location information, associated with a stored portion of package information at the server, matches the location information sent by the client processor via the network.

10. The system of claim 1, further comprising a plurality of client devices, each client device comprising a corresponding client processor configured to determine whether or not a potential delivery location, identified by corresponding location information, is the target delivery location for a corresponding package by:
sending, to a server via a network, the package information for the corresponding package and the corresponding location information;
sending, to the server via the network, a request for confirmation of whether or not the potential delivery location is the target delivery location; and
receiving, from the server via the network, the confirmation of whether or not the delivery location, identified by the location information, is the target delivery location.

11. A computer program product comprising:
one or more computer-readable storage media; and
program instructions stored on the one or more computer-readable storage media to perform operations comprising:
acquiring encoded package data, representing package information which identifies a package;
acquiring encoded location data, representing location information which identifies a delivery location;
determining whether or not the delivery location, identified by the location information, is a target delivery location for the package based on:
a plurality of stored portions of package information, each stored portion of package information identifying a different package; and
a plurality of stored portions of location information, each stored portion of location information identifying a different target delivery location for a corresponding package and each stored portion of location information being associated with a corresponding stored portion of package information; and
in a case that it is determined that the delivery location is the target delivery location for the package, providing a notification that the delivery location is the target delivery location; and
in a case that it is determined that the delivery location is not the target delivery location for the package, providing a notification that the delivery location is the not target delivery location.

12. The computer program product of claim 11, wherein the operations further comprise:
storing the plurality of portions of package information;
storing each of the plurality of portions of location information in association with the corresponding portion of package information; and
determining whether or not the delivery location, identified by the location information, is the target delivery location by:
searching for a stored portion of package information corresponding to the package information which identifies the package; and
determining whether or not a stored portion of location information, associated with the stored portion of package information, matches the location information which identifies the delivery location.

13. The computer program product of claim 11, wherein the operations further comprise:
acquiring the encoded package data by optically scanning the encoded package data of a package identifier; and
acquiring the encoded location data by optically scanning the encoded location data of a location identifier.

14. The computer program product of claim 11, wherein the operations further comprise:
acquiring the encoded package data by reading the encoded package data of a package information device via a short range communication protocol; and
acquiring the encoded location data by reading the encoded location data of a location information device via the short range communication protocol.

15. The computer program product of claim 11, wherein the operations further comprise:
decoding the encoded package data into the package information which identifies the package; and
decoding the encoded location data into the location information which identifies the delivery location.

16. A computer implemented method of authenticating secure package delivery, the method comprising:
acquiring, by a client processor, encoded package data, representing package information which identifies a package;
acquiring, by a client processor, encoded location data, representing location information which identifies a delivery location;
determining, by a client processor, whether or not the delivery location, identified by the location information, is a target delivery location for the package based on:
a plurality of stored portions of package information, each stored portion of package information identifying a different package; and
a plurality of stored portions of location information, each stored portion of location information identifying a different target delivery location for a corresponding package and each stored portion of location information being associated with a corresponding stored portion of package information; and
in a case that it is determined that the delivery location is the target delivery location for the package, providing, by a client processor, a notification that the delivery location is the target delivery location; and
in a case that it is determined that the delivery location is not the target delivery location for the package, providing, by a client processor, a notification that the delivery location is the not target delivery location.

17. The computer implemented method of claim 16, further comprising:
storing the plurality of portions of package information;
storing each of the plurality of portions of location information in association with the corresponding portion of package information; and
determining whether or not the delivery location, identified by the location information, is the target delivery location by:
searching for a stored portion of package information corresponding to the package information which identifies the package; and
determining whether or not a stored portion of location information, associated with the stored portion of package information, matches the location information which identifies the delivery location.

18. The computer implemented method of claim 16, further comprising:
acquiring the encoded package data by optically scanning the encoded package data of a package identifier; and
acquiring the encoded location data by optically scanning the encoded location data of a location identifier.

19. The computer implemented method of claim 16, further comprising:
acquiring the encoded package data by reading the encoded package data of a package information device via a short range communication protocol; and
acquiring the encoded location data by reading the encoded location data of a location information device via the short range communication protocol.

20. The computer implemented method of claim 16, further comprising:
decoding the encoded package data into the package information which identifies the package; and
decoding the encoded location data into the location information which identifies the delivery location.
